(19) United States
(12) Patent Application Publication
(10) Pub. No.: US 2016/0188816 A1
(43) Pub. Date: Jun. 30, 2016

(54) METHOD FOR COST-BASED EVALUATION OF A SERVICE DELIVERY NETWORK

(71) Applicant: Aditazz, Inc., Brisbane, CA (US)

(72) Inventor: Alexander Khainson, San Carlos, CA (US)

(73) Assignee: Aditazz, Inc., Brisbane, CA (US)

(21) Appl. No.: 14/979,486

(22) Filed: Dec. 27, 2015

Related U.S. Application Data
(60) Provisional application No. 62/096,971, filed on Dec. 26, 2014.

(51) Int. Cl. G06F 19/00

(52) U.S. Cl. CPC G06F 19/327

(57) ABSTRACT

An embodiment of a computer based method for evaluating a service delivery network for a geographic region that provides a set of services via a set of facilities within the geographic region is disclosed. In an embodiment, the method involves identifying existing and projected geographically distributed demand for a set of services within the geographic region over a desired time horizon and finding an optimal allocation of the set of services to a set of existing and potential new facilities over the desired time horizon, wherein the set of existing and potential new facilities are located within the geographic region. Additionally, the optimal allocation is a function of the capital expense and the operating expense of providing the services over the desired time horizon.

### CROSS REFERENCE TO RELATED APPLICATIONS

This application is entitled to the benefit of provisional U.S. Patent Application Ser. No. 62/096,971, filed Dec. 26, 2014, which is incorporated by reference herein.

### FIELD OF THE INVENTION

The invention relates generally to evaluation of a service delivery network, for example, the evaluation of a healthcare delivery network.

### BACKGROUND

Organizations dedicated to providing healthcare services to the population of a particular geographic region typically provide healthcare services through a geographically dispersed set of facilities. The geographically dispersed set of facilities may include, hospitals and other satellite facilities such as medical office buildings, clinics, emergency services buildings, physical therapy buildings, and express diagnostic labs. The set of geographically dispersed facilities under the management of a healthcare organization can be collectively referred to as a healthcare delivery network.

The existing and projected population of a particular geographic region will drive the existing and future demand for healthcare services in the geographic region. Additionally, because the population is geographically distributed throughout the region, the existing and future demand has a geographical dimension. Given an existing and projected population of a particular geographic region, a healthcare organization will try to plan a healthcare delivery network within the region that can meet existing and future demand in a cost efficient manner. That is, decisions made with respect to the planning of a healthcare delivery network should take into consideration the impact on capital expenses (CAPEX) and the impact on operating expenses (OPEX).

In reality, there are many different variables that will affect the CAPEX and OPEX of a healthcare delivery network and the variables will change over time, such as over a planning horizon of 5, 10, 20, or 30 years. Variables may include changes in demand, changes in facilities (e.g., new facilities being put into service, existing facilities being expanded, and/or old facilities being taken out of service), and changes in the types and volumes of services that are provided in each facility. Such variables have to this point made it difficult, if not impossible, for planners to understand how different healthcare delivery network planning decisions will affect the cost of delivering healthcare services in terms of CAPEX and OPEX. Additionally, it is very difficult for planners to find certain configurations of a healthcare delivery network that will minimize cost, e.g., in terms of CAPEX and OPEX, while meeting existing and projected demand over a desired time horizon.

### SUMMARY

An embodiment of a computer based method for evaluating a service delivery network for a geographic region that provides a set of services via a set of facilities within the geographic region is disclosed. In an embodiment, the method involves identifying existing and projected geographically distributed demand for a set of services within the geographic region over a desired time horizon and finding an optimal allocation of the set of services to a set of existing and potential new facilities over the desired time horizon, wherein the set of existing and potential new facilities are located within the geographic region. Additionally, the optimal allocation is a function of the capital expense and the operating expense of providing the services over the desired time horizon.

In an embodiment, the method further involves modifying an aspect of the healthcare delivery network and finding an optimal allocation of the set of services to a set of existing and potential new facilities over the desired time horizon taking into consideration the modified aspect of the healthcare delivery network.

In an embodiment, a computer based method for evaluating a service delivery network for a geographic region is disclosed. The method involves identifying a geographic distribution of existing demand for a set of services within a geographic region, identifying a geographic distribution of projected demand for the set of services within the geographic region at a future time, identifying the locations of existing service delivery facilities within the geographic region, identifying the locations of potential new service delivery facilities within the region, assigning the set of services to the existing and potential new service delivery facilities, identifying a capacity to provide the set of services at each existing and potential new service delivery facility, allocating the existing and projected demand for the services amongst the existing and potential new facilities without exceeding the identified capacity, calculating capital expenses and operating expenses for the allocations, and finding optimal allocations for the service delivery network as a function of time in view of the capital expense and the operating expense calculations.

In an embodiment, the method further involves modifying an aspect of the service delivery network and finding optimal allocations for the service delivery network as a function of time in view of the capital expense and the operating expense calculations taking into consideration the modified aspect of the service delivery network.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block flow diagram of a technique for generating a healthcare delivery network model in accordance with an embodiment of the invention.

FIG. 2 depicts a map of a geographic region that includes a centrally located large city, multiple surrounding smaller cities, and a network of roads.

FIG. 3 depicts the region shown in FIG. 2 divided into multiple geographic demand areas.

FIG. 4 depicts the location of certain types of existing and potential new facilities within the healthcare delivery network that supports the region shown in FIGS. 2 and 3.

FIG. 5 depicts an expanded functional block diagram of the network assignment and analysis module of FIG. 1.

FIG. 6 depicts a portion of the transportation network description for the region to be covered by the healthcare delivery network.

FIG. 7 depicts the region described above with reference to FIGS. 2-4 and 6 in which travel paths between a demand area and two different facilities are highlighted.

FIG. 8 is a graphical depiction of time intervals that correspond to time intervals used in an operating expense calculation.

FIG. 9 is a graphical output that can be generated using the technique for generating a healthcare delivery network model.

FIG. 10 depicts an embodiment of a computer architecture in which the technique for generating a healthcare delivery network model can be implemented.

FIG. 11 is a process flow diagram of a method for evaluating a service delivery network for a geographic region that provides a set of services via a set of facilities within the geographic region in accordance with an embodiment of the invention.

FIG. 12 is a process flow diagram of a method for evaluating a service delivery network for a geographic region in accordance with an embodiment of the invention.

Throughout the description, similar reference numbers may be used to identify similar elements. Additionally, in some cases, reference numbers are not repeated in each figure in order to preserve the clarity and avoid cluttering of the figures.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

### Problem to be Solved

The existing and projected population of a particular geographic region will drive the existing and future demand for healthcare services in the geographic region. It should be noted that healthcare demand for a particular healthcare organization should take in to account market penetration/demand of the healthcare organization. For example, a healthcare organization may estimate demand for healthcare services that are provided by the healthcare organization based on the number of people that are covered by the healthcare organization and projected changes in the number of people that will be covered in the future. Additionally, because the population is geographically distributed throughout the region, the existing and future demand has a geographical dimension. Given the geographically distributed demand (both existing and future) within a particular region for healthcare services and a geographically dispersed set of existing and potential new healthcare facilities, an important task for a healthcare organization is to generate a healthcare delivery network model that can be used for planning purposes over a desired time horizon. For example, it is desirable to generate a healthcare delivery network model that can satisfy the existing and future demand for healthcare services over the desired time horizon and that defines the evolution of the physical distribution of the facilities in the healthcare delivery network as well as the assignment of the types and volume of healthcare services to the facilities. For example, a healthcare delivery network model specifies the location of each facility over the desired time horizon and the types and volumes of services that will be provided at the facilities over that time horizon. Additionally, it is important that the healthcare delivery model satisfies the existing and future demand for healthcare services in a cost efficient manner, e.g., with respect to both CAPEX and OPEX.

### Embodiment of the Invention

A technique for generating a healthcare delivery network model that can satisfy the existing and future demand for healthcare services over a desired time horizon and that defines the evolution of the physical distribution of the facilities in the healthcare delivery network as well as the assignment of the types and volume of healthcare services to the geographically dispersed set of facilities involves applying a combination of computer-based modeling, simulation, and optimization techniques to automatically generate a healthcare delivery network model that is cost effective in terms of both CAPEX and OPEX. For example, given a range of demand projections, a desired time horizon, a list of existing and potential new service facility locations, a transportation network, and estimates of capital and operating expenses per unit of different services, a computer-implemented system generates a healthcare delivery network model or models that minimize the cost (e.g., in terms of CAPEX+OPEX) of healthcare delivery while satisfying the demand for services over the specified time horizon. The healthcare delivery network model can help to, for example, identify where to locate hospitals and satellite offices of different types and when to increase their numbers and/or capacity to satisfy changing demand and/or to improve market penetration/share (e.g., in markets with multiple competing healthcare organizations) while providing an idea of the cost impact (e.g., in terms of CAPEX+OPEX) of such decisions.

In an embodiment, the technique involves a two step computer-implemented optimization approach. A first step involves the assignment of services to given network facilities (both existing and potential future) for a specified period of time. In an embodiment, the services are assigned to the facilities based on proximity, user preferences, and availability of service. Optimal assignments of services to facilities can be determined based on, for example, the quality and cost of services (e.g., is demand satisfied, what is the utilization rate of the facilities, etc.).

In an embodiment, the first step involves computer-based modeling, simulation, and optimization processes. For example, the computer-based modeling, simulation, and optimization processes include the following steps: subdividing of the service region into service areas; estimating the volume of specific services based on a range of demographic projections and market penetration/share for each area as a function of time; defining locations and service capacities (per each service type) for existing and potential new facilities; and assigning services to given network facilities for a specified period of time. In an embodiment, optimal assignment of services to facilities is based on user demand, transportation cost, facilities utilization, and user preferences. This process may also include calculating capital and operating expenses (CAPEX and OPEX) for each facility and service.

A second step involves optimization of the healthcare delivery network model (i.e., the locations of facilities, the types and volumes of services to be provided at the facilities) as a function of time to minimize the total cost (e.g., CAPEX+OPEX) over the desired time horizon. For example, the facilities network configuration (i.e., locations of facilities, availability and volumes of services) is optimized to minimize total cost of operating, development, and modifying the facilities network (CAPEX+OPEX) over the desired time horizon.

Implementation

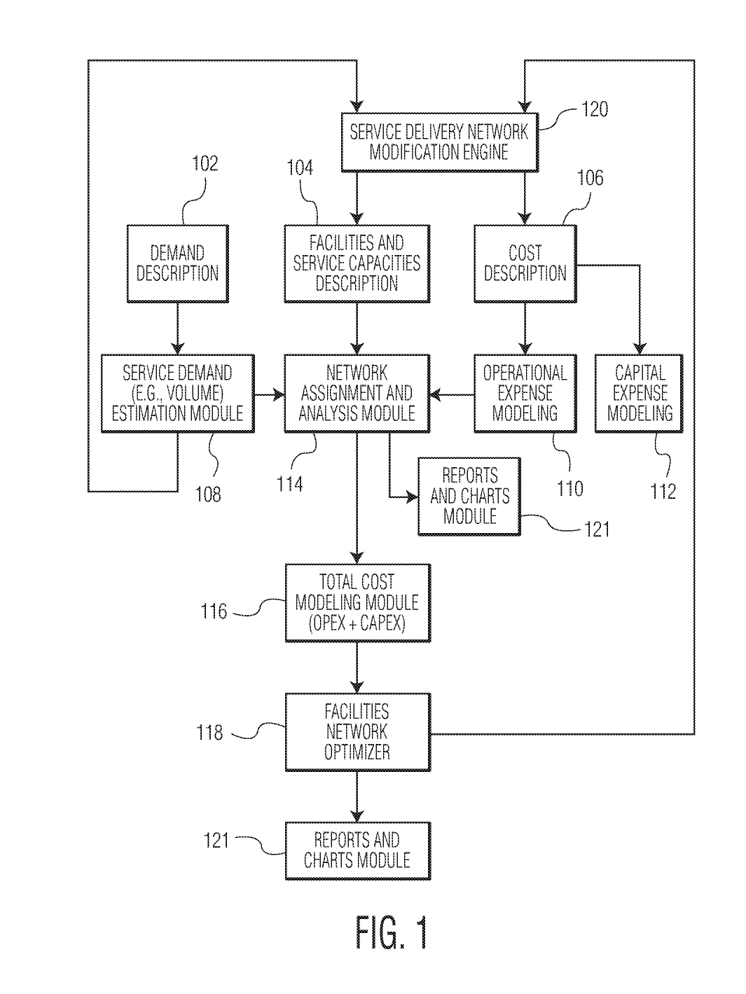

An embodiment of a technique for producing a healthcare delivery network model is described below with reference to FIGS. 1-11. FIG. 1 is a block flow diagram of a computer-based technique for generating and evaluating a healthcare delivery network model in accordance with an embodiment of the invention. The healthcare delivery network model is applicable to a desired time horizon (e.g., 5, 10, 20, or 30 years) and therefore, as is described below, certain operations correspond to certain time intervals within the desired time horizon. The block flow diagram includes a demand description (block 102), a facilities and service capacities description (block 104), a cost description (block 106), a service demand estimation module (block 108), operational modeling (block 110), capital expense modeling (block 112), a network assignment and analysis module (block 114), a total cost modeling module (block 116), a facilities network optimizer (block 118), a service delivery network modification engine (block 120), and reports and charts module (block 121). Each block is described below in logical order.

Demand Description

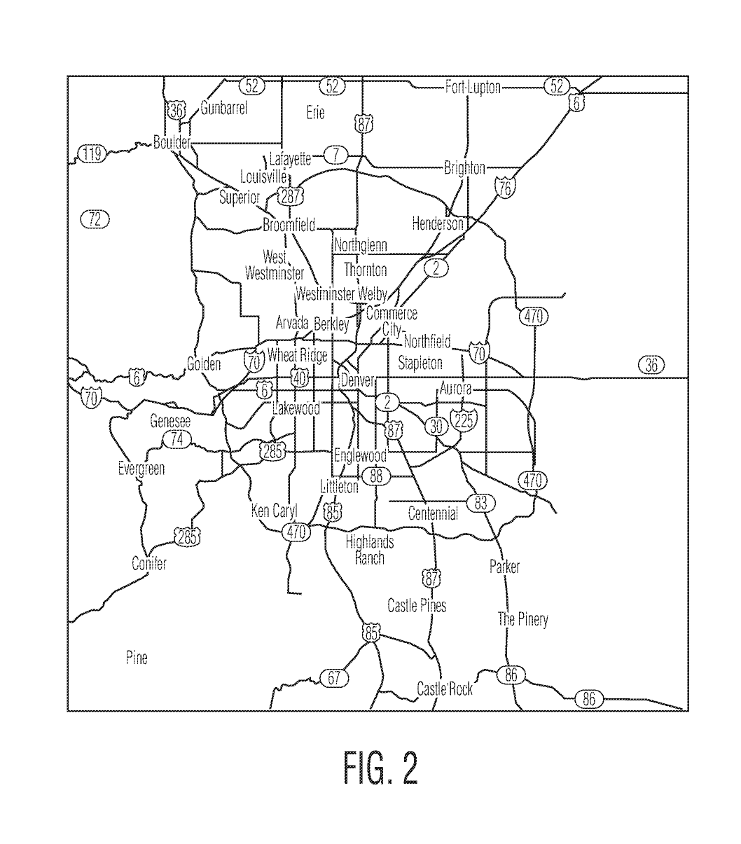

With reference to FIG. 1, at block 102, a demand description is generated. In an embodiment, a demand description is generated for a particular geographic region that is to be serviced by a healthcare organization. For example, FIG. 2 depicts a map of a geographic region that includes a centrally located large city (e.g., Denver, Colo.), multiple surrounding smaller cities (e.g., Lakewood, Aurora, Broomfield, Centennial, etc.), and a network of roads (e.g., highways 70, 76, 225, etc.). The geographic region includes a geographically distributed population of residents with more dense population around the cities. The population of the region can be used along with market penetration/share information to estimate the demand for certain types of healthcare services and since the population has a geographic distribution, the demand for healthcare services has a geographic distribution. The projected population and market penetration/share of the region can also be estimated over the desired time horizon using known data, e.g., government census data. The projected demand for certain types of healthcare services can also be estimated from the projected population and market penetration/share information over the desired time horizon.

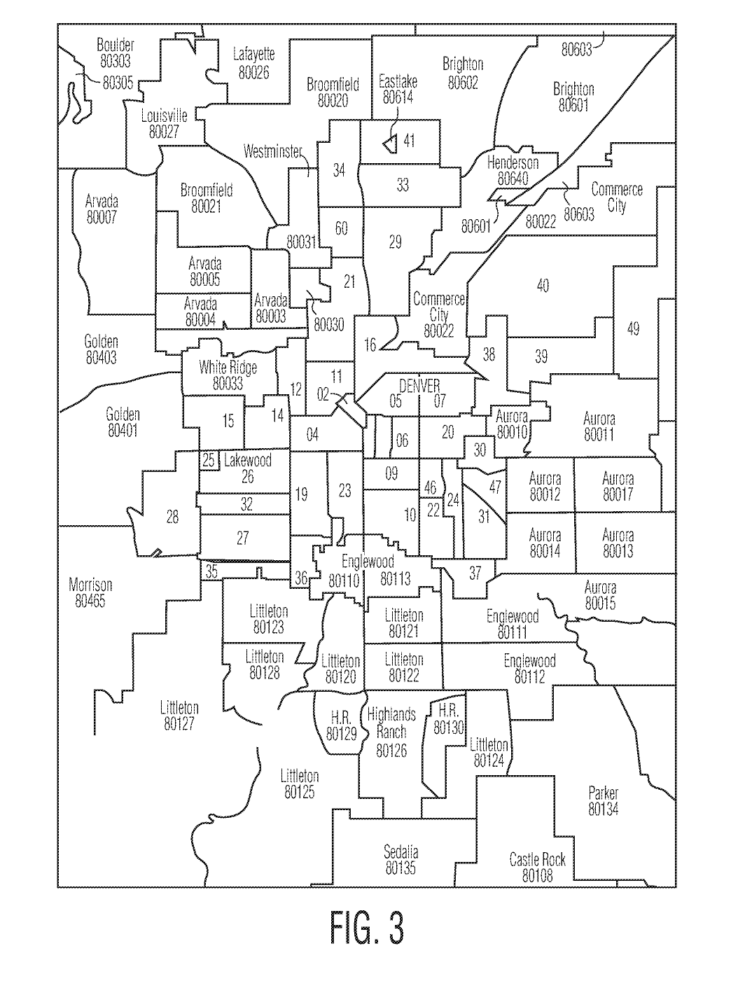

In an embodiment, the demand description is captured and stored in a formal description as described below. A first step in generating the formal description involves dividing the region into multiple geographic demand areas. FIG. 3 depicts a portion of the region shown in FIG. 2 divided into multiple geographic demand areas. In the embodiment of FIG. 3, each demand area corresponds to the geographic areas defined by the ZIP codes (e.g., postal codes) in the region. Although in the example of FIG. 3 the region is divided into demand areas by ZIP code, the region could be divided into different shaped demand areas, different sized areas, or based on different criteria, such as city/county boundaries, population characteristics, etc., as long as the area has a defined geographic location. In an embodiment, each demand area is a hexagon that has specific geographic coordinates and the entire region is divided into multiple contiguous equal-sized hexagons. In another embodiment, the physical sizes of the demand areas are set based on physical dimensions and cover about the same number of square miles per demand area and in another embodiment, the sizes of the demand areas are population based such that each demand area has about the same population. The demand areas can be set using other criteria and/or a combination of different criteria.

The demand description also includes defining the types of healthcare services that will be offered by the healthcare delivery network within the region. For example, the types of healthcare services may include emergency room care, cardiac surgery, general surgery, patient recovery, cancer treatment, physical therapy, diagnostics, pediatric care, prenatal care, and postnatal care. In an embodiment, the demand description is defined as follows:
Aₙ—Demand area, n=1, . . . N, where N is the total number of areas served by the healthcare delivery network.
Sₖ—Type of medical service, k=1, . . . K, where K is the total number of services considered. In an embodiment, services types are organized in hierarchical groupings of payable services.

In an embodiment, a region may be divided into 100 different demand areas (e.g., N=100) and the healthcare organization may offer hundreds of different services types (e.g., K=100). Therefore, for each give time period, t, the number of demand area/service type combinations is 100*100=10,000. Examples of different types of services that are provided in a healthcare delivery network are identified in Table 1.

TABLE 1

| | |
|---|---|
| DIAGNOSTIC | Nuclear medicine, nuclear radiology, radiology, diagnostic radiology |
| IMAGING | |
| EMERGENCY | Emergency medicine, urgent care, acute care. |
| GENERAL | Family practice, general practice |
| PRACTICE | |
| INTERNAL | Allergy and immunology, cardiology, cardiology facility, |
| | cardiovascular disease, dermatology, dialysis center, endocrinology, |
| | metabolism, gastroenterology, geriatrics, gastrointestinal facility, |
| | hospital, infectious disease, internal medicine, nephrology, neurology, |
| | pulmonary disease, rheumatology, sleep medicine, sports medicine |
| LABORATORY | Laboratory, reference laboratory |
| OBSTETRICS AND | Gynecological oncology, gynecology, obstetrics, reproductive |
| GYNECOLOGY | endocrinology |
| PATHOLOGY | Pathology, neuropathology |
| PEDIATRIC | Adolescent medicine, neonatology, pediatric allergy, cardiology, |
| | endocrinology, gastroenterology, hematology, oncology, infectious |
| | disease, nephrology, neurology, otolaryngology, pathology, |
| | pulmonology, radiology, rheumatology, surgery, and urology, |
| | perinatology |
| REHABILITATION | Occupational medicine, orthotics and prosthetics, physical medicine and |
| | rehabilitation, physical therapy, rehabilitation therapy |
| SURGERY | Abdominal, ambulatory, cardiovascular, colon and rectal, general, hand, |
| | head and neck, maxillofacial, neurological, neurosurgery, |
| | ophthalmology, orthopedic, outpatient, plastic, thoracic, trauma, |
| | urology, vascular, wound care |

Facilities and Service Capacities Description

Referring back to FIG. 1, at block 104, a facilities and service capacities description is generated. In an embodiment, the facilities and service capacities description includes a formal description of the location (e.g., geographic coordinates) of the existing facilities in the healthcare delivery network as well as a description of the location of potential new facilities. The potential new facilities could include facilities that have a wide range of potential for actually becoming usable facilities. For example, some potential new facilities may have a high probability of becoming usable facilities and may even have a specific planned time for completion, while other facilities may have an undefined probability for becoming usable facilities with no planned time horizon. In addition to the location of each existing and potential new facility, the capacity to perform healthcare services (e.g., on a per-service type basis) is associated with each facility. For example, a number of units of service per unit time (e.g., emergency room beds per day) for each service type is associated with each facility. The combination of the location of the facilities and the assigned capacity to provide specific types of healthcare services defines a geographically distributed model of the service capacity of the healthcare delivery network. In addition to the geographically distributed model of the service capacity of the health care delivery network, the facilities and service description may include a relative ranking of how desirable (e.g., from a cost and/or customer satisfaction perspective) it is to provide a particular service at a particular facility relative to the other facilities in the healthcare delivery network. For example, the relative ranking may be a numeric value from 1 to 100 that is assigned by a user of the system with “1” being a relatively low ranking (less desirable) and “100” being a relatively high ranking (more desirable). The relative ranking may be based on, for example, publically available data, internal private data (e.g., patient satisfaction surveys, scheduling data), and doctor preferences.

In an embodiment, demand description is defined as follows:
Fₘ—Facility at given location (Xₘ, Yₘ), m=1, . . . M, where M is total number of existing and potential new facilities (Xₘ, Yₘ being coordinates of the location of the facility);
SFₖₘ—Capacity to perform medical service of type Sₖ at the facility Fₘ. (Potential new facilities do not provide any service at the current moment, i.e., SFₖₘ=⁰);
RRSFₖₘ—Relative ranking of medical service of type Sₖ at the facility Fₘ. The value represents the desirability of providing service Sₖ at facility Fₘ relative to the other facilities in the healthcare services delivery network.

In an embodiment, a healthcare delivery network in a region may include several dozen different existing and potential new facilities (e.g., M=24). Therefore, the possible number of different service/facility combinations (if every facility were able to offer every service) is on the order of 24*100=2,400.

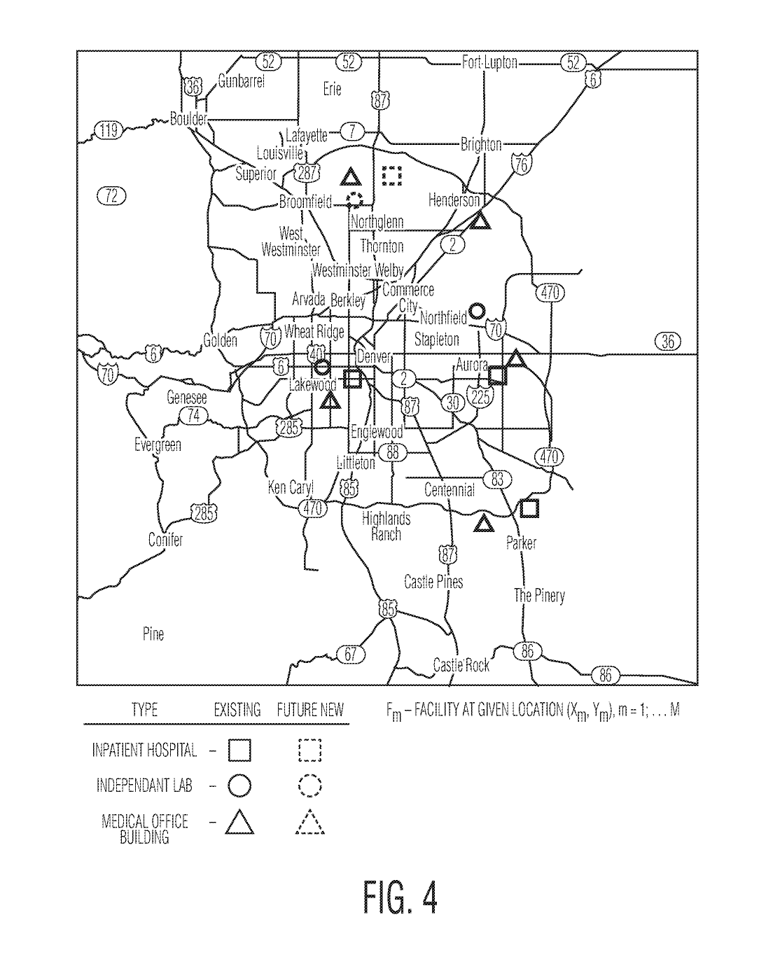

With regard to the facilities and service capacities description, FIG. 4 depicts the location of certain types of existing and potential new facilities within the healthcare delivery network that supports the region shown in FIGS. 2 and 3. For example, FIG. 4 depicts the locations of existing and potential new inpatient hospitals, independent labs, and medical office buildings. Although a few example facilities are depicted in FIG. 4, it is possible that more (or fewer) facilities are included in the healthcare delivery network. Examples of types of facilities and services provided within the healthcare delivery network are shown in Table 2, although other types of facilities are possible.

TABLE 2

| | |
|---|---|
| INPATIENT | A facility, other than psychiatric, that primarily provides diagnostic, |
| HOSPITAL | therapeutic, and rehabilitation services by physicians for admitted patients. |
| INDEPENDENT | A laboratory certified to perform diagnostic or clinical tests independent of |
| LAB | an institution or a physician's office. |
| OFFICE | Location where the health professional routinely provides health |
| | examinations, diagnosis, and treatment of illness or injury on an |
| | ambulatory basis. |
| OUTPATIENT | Hospital that provides diagnostic, therapeutic (both surgical and |
| HOSPITAL | nonsurgical), and rehabilitation services to sick or injured persons who do |
| | not require hospitalization or institutionalization. |
| URGENT CARE | Urgent care facility: Location whose purpose is to diagnose and treat |
| | illness or injury for unscheduled, ambulatory patients seeking immediate |
| | medical attention. |

Cost Description

Returning back to FIG. 1, at block 106, a cost description is provided. In an embodiment, the cost description includes defining certain costs (e.g., in terms of dollars) associated with the healthcare delivery network. For example, the cost description may include assigning CAPEX costs for construction and modification of facilities, OPEX costs for operating the facilities, and OPEX costs for providing each of the types of services on, for example, a per unit basis. As is described below, the cost description will be used at blocks 110 and 112 in subsequent CAPEX and OPEX modeling. Such CAPEX and OPEX information can be provided from various sources including publically available cost data and proprietary cost data, such as data from a healthcare organization and cost data from the building industry.

Services Demand Estimation Module

With reference to FIG. 1, at block 108, a service demand estimation is provided. In an embodiment, a service demand estimation includes an estimate of the volume of services (e.g., units of service per unit of time, such as ten abdominal surgeries/month) that will be needed on a per-service basis. The service demand estimation is based at least in part on information from the demand description. In an embodiment, the services demand estimation is an estimate of the volume per service type per demand area. For example, the services demand estimation will provide an estimate of the geographically distributed volume of healthcare services that will need to be performed on a temporal basis (e.g., per month, quarter, year), including emergency room care, cardiac surgery, general surgery, patient recovery, cancer treatment, physical therapy, diagnostics, pediatric care, prenatal care, and postnatal care. Ultimately, it is desirable for the healthcare services delivery network to fully support the estimated demand for the services. Demand for services is also a function of market share. That is, the population of a region may have an overall demand, but the healthcare organization services less than 100% of the overall demand. In an embodiment, the service volume estimation is defined as follows:
SAₖₙ(t)—estimated demand (e.g., in volume/units of services needed) for service Sₖ from the demand area Aₙ at time, t. SAₖₙ(t) can reflect future projections of demand and can change as a function of time, for example, demand projections in 5 and 10 years.

In an embodiment, a region may be divided into 100 different demand areas (e.g., N=100) and the healthcare organization may offer hundreds of different services types (e.g., K=100). Therefore, for each give time, t, the number of demand area/service type combinations is 100*100=10,000. For example, at time t1, the demand area/service type combinations are identified as: SA₁₁-SA₁₀₀₁₀₀. Since demand can change over time, the service volume estimates can be adjusted at different times, e.g., at 5, 10, 15, 20, 25, and 30 years.

Operational Expense Modeling

Referring again to FIG. 1, at block 110, operational expense (OPEX) modeling is performed using data from the cost description. In an embodiment, the cost of providing a unit of a particular service at a particular facility is expressed as:
CSFₖₘ—cost of providing unit of service Sₖ at facility Fₘ during defined time period.

For example, the cost (in dollars/month or dollars/year) of providing an emergency room bed at an existing hospital facility is modeled and the cost (in dollars/procedure) of providing an abdominal surgery at an existing hospital facility is modeled. In an embodiment in which there are 100 types of services and 24 facilities, there are 2,400 different operating cost possibilities. The OPEX cost models can be used in the network assignment and analysis module and the total cost modeling module as described below.

Network Assignment and Analysis Module

Referring again to FIG. 1, at block 114, the network assignment and analysis module is configured to assign the geographically distributed demand for services to the geographically distributed facilities in a cost-effective manner and to analyze the assignments based on factors such as operational cost, demand satisfaction, and utilization.

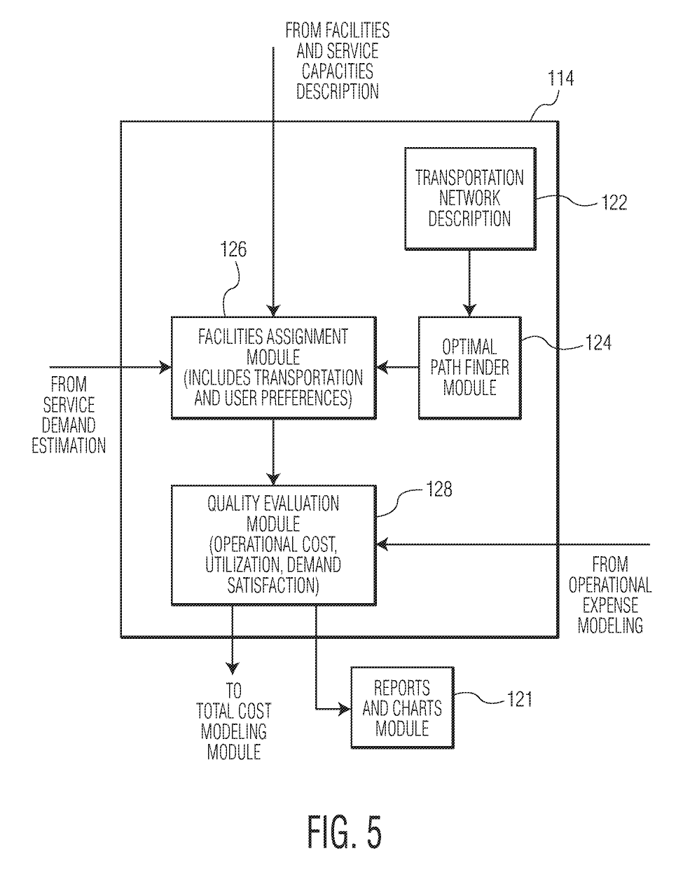

FIG. 5 depicts an expanded functional block diagram of the network assignment and analysis module (block 114) of FIG. 1. As shown in FIG. 5, the network assignment and analysis module includes a transportation network description (block 122), an optimal path finder module (block 124), a facilities assignment module (block 126), and a quality evaluation module (block 128). Each of the elements is described below.

Transportation Network Description

Referring to block 122, a transportation network description is generated. In an embodiment, the transportation network description defines costs for traveling within the region associated with the healthcare delivery network. For example, the transportation network description defines costs for travel between each demand area and each facility in the healthcare delivery network (e.g., geographically distributed demand areas and facilities as described above). The costs may be defined in terms of, for example, time, money, patient satisfaction or a combination thereof. In an embodiment, the cost of travel is defined in terms of the time required to travel between a demand area and a specific facility in the healthcare delivery network. The time can be calculated using, for example, known electronic mapping applications (e.g., GOOGLE MAPS, MAPQUEST, etc), which are capable of calculating times using various modes of transportation (e.g., driving, public transportation, walking) and various routes.

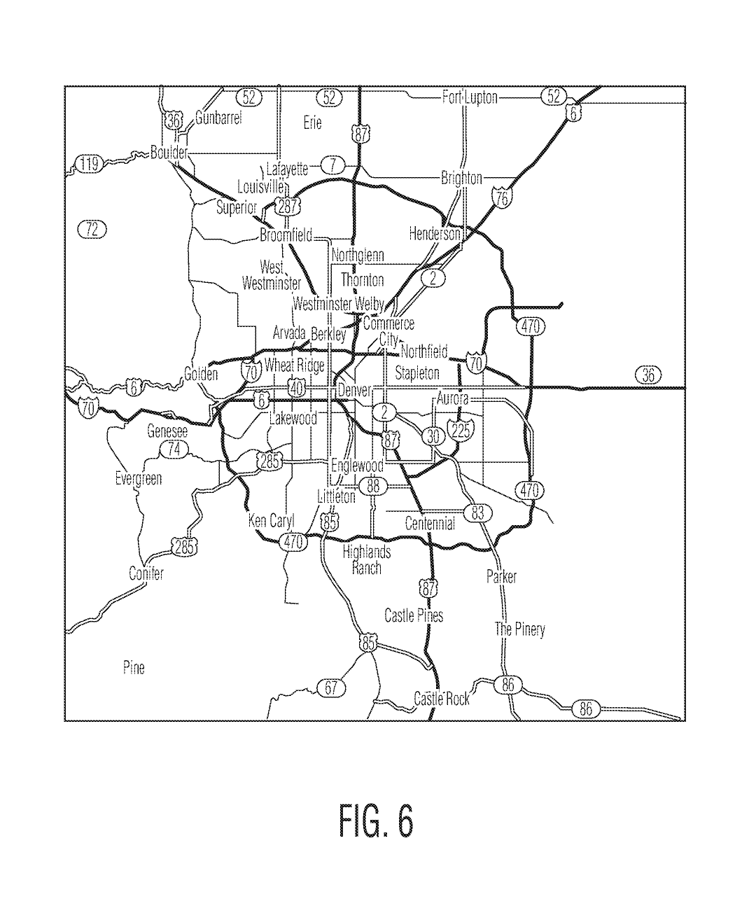

FIG. 6 depicts a portion of the transportation network description (e.g., public roads) for the region to be covered by the healthcare delivery network. Although FIG. 6 depicts only certain public roads in the region, the transportation network description can include more detailed transportation network information (e.g., driving/roads, public transportation, walking) as mentioned above and as is known in the field of electronic mapping applications. The transportation network description is used, as described below, to find optimal paths between the demand areas and the facilities in the healthcare delivery network.

Optimal Path Finder Module

Referring to block 124, an optimal path finder is configured to find optimal paths between previously defined and geographically distributed demand areas and facilities. In an embodiment, the optimal paths are found by computing the cost between the service areas in the facilities. For example, travel costs can be expressed as:
TAFₙₘ—unit cost of transportation between area Aₙ and facility Fₘ.

In an embodiment in which there are 100 demand areas (N=100) and 24 facilities (M=24), there are at least 100*24=2,400 different transportation costs, assuming only one transportation path is considered for each AFₙₘ combination.

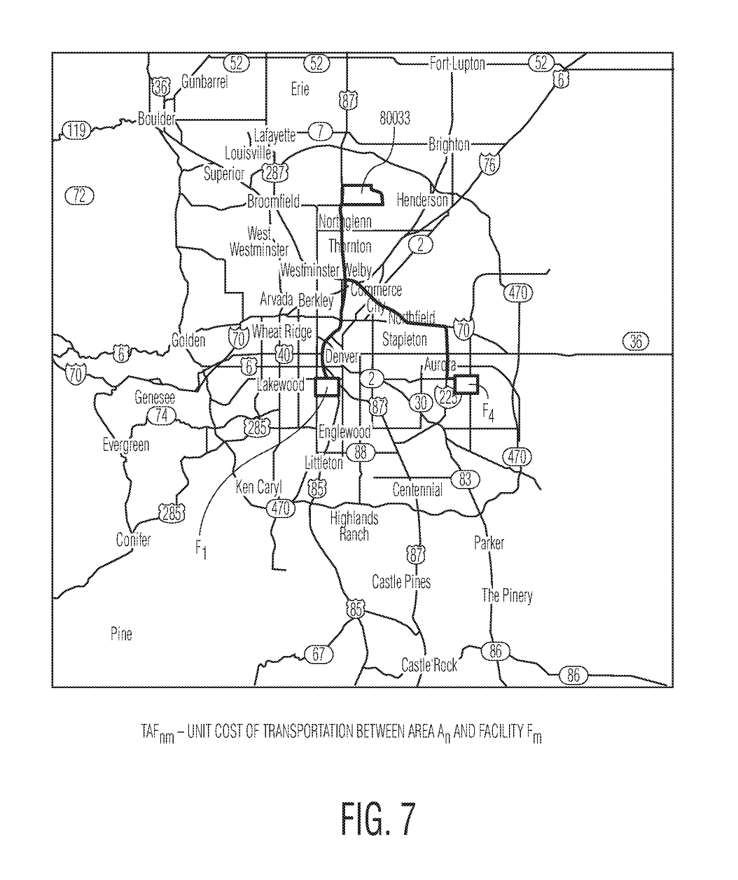

In an embodiment, transportation costs (e.g., in terms of time) are used to find the lowest cost (e.g., optimal) paths from a particular demand area to a particular facility that provides a particular service. For example, from a particular demand area, there may be two different facilities that provide abdominal surgery service (e.g., two different inpatient hospital facilities that can provide such service). A different transportation cost can be calculated for a trip from the particular demand area to each of the two different facilities using, for example, an electronic mapping application. The transportation costs can be used to identify the facility that requires the least amount of travel time as the lowest cost or optimal facility. FIG. 7 depicts the region described above with reference to FIGS. 2-4 and 6 in which travel paths between a demand area (e.g., ZIP code 80033) and two different facilities (e.g., inpatient hospitals F₁ and F₄) are highlighted. In an embodiment, the transportation costs are calculated (e.g., in terms of time) for travel between the demand area and the two different facilities and the lowest cost or optimal facility is the facility with the shortest travel time. Note that it is possible that the lowest cost or optimal facility is not the physically closest facility but rather the facility that requires the least amount of travel time. Other travel “cost” considerations may be taken in to account such as convenience, public transportation, private transportation, traffic patterns (e.g., commute patterns) etc., when quantifying the cost that corresponds to a particular service area/facility combination.

Facilities Assignment Module

Referring back to FIG. 5, at block 126, the facilities assignment module is configured to perform facilities assignment optimization using input from the service demand estimation module, input from the facilities and service capacities description, and input from the optimal path finder module. In an embodiment, the goal of the facilities assignment module is to assign specified demand for certain services to the facilities and to evaluate the utilization of the facilities and the cost of providing the services at the assigned facilities. In an embodiment, the analysis is based on static modeling and optimal assignment of services to facilities is based on demand, transportation cost, facilities utilization, and user preferences.

In an embodiment, services of all types for each demand area are assigned to available facilities in the healthcare delivery network based on transportation cost, facility load (availability of service at the facility and utilization rate of the service at the facility), and facility service relative ranking (e.g., the facility's reputation). For example, in demand area A₁, the entire volume of services, S₁-S_{K}, (e.g., expressed as SA₁₁, . . . SA_{K1}) are assigned to specific facilities, Fₘ. The process is repeated for each of the other demand areas, A₂-A_{N}. In an embodiment, all of the demand (e.g., total demand of the population serviced by the healthcare organization) for services is assigned to at least one facility within the healthcare services delivery network.

In an embodiment, the assignment operation involves assigning 100 service types to 24 facilities for each of 100 demand areas. This involves on the order of 100*24*100=240,000 unique assignments. This operation can be accomplished in a computer-based operation as described below.

Facilities Assignment Operation

The facilities assignment operation involves assigning the services (Sₖ) for each demand area (Aₙ) to at least one facility (Fₘ) in the healthcare services delivery network.

Integer Programming Formulation

In an embodiment, the assignment of services for demand areas to facilities utilizes an optimization variable, αₖₙₘ, which represents the assignment of services, Sₖ, for a demand area, Aₙ, to a facility, Fₘ. For example, the following optimization variable can be expressed as:
αₖₙₘ=1, if service Sₖ for demand area Aₙ is assigned to facility Fₘ;
αₖₙₘ=0 otherwise.

The above expression of the optimization variable assumes that all services of a given type for the demand area are performed at the same facility.

Continuous Optimization Formulation

It is also possible that services, Sₖ, of a demand area, Aₙ, could be split between one or more facilities, Fₘ. If services are divided between different facilities, then continuous formulation is needed and the optimization variable can be expressed as:
0<=αₖₙₘ<=1, where, αₖₙₘ, represents the portion of service Sₖ for demand area Aₙ that is assigned to facility Fₘ;
   and;

$${\sum }_{k = 1}^{k <= K} {α}_{knm} = 1$$

such that the entire demand for service, Sₖ, for demand area, Aₙ, is assigned to one or more facilities, Fₘ.

Optimization Problem

In an embodiment, the optimization problem can be characterized as a task to assign service demand per area to the facilities in a manner that minimizes transportation cost between the demand areas and the facilities with the facilities desirability being weighted by relative rankings. In an embodiment, the optimization problem is expressed in terms of the above-identified parameters as:

$$min {\sum }_{k = 1}^{k <= K} {\sum }_{m = 1}^{m <= M} {\sum }_{n = 1}^{n <= N} {α}_{knm} * {TAF}_{nm} * {RRSF}_{km} * {SA}_{kn}$$

where,
TAFₙₘ—unit cost of transportation between area Aₙ and facility Fₘ;
RRSFₖₘ—Relative Ranking of providing service Sₖ at facility Fₘ; and
SAₖₙ—demand (e.g., in units of services needed) for service Sₖ from the area Aₙ; and
in an example, N=100, K=100, and M=24.

In an embodiment, the ultimate goal is to find the set, or sets, of optimization variables, αₖₙₘ, for N=100, K=100, and M=24 that has a minimum or near minimum “cost.” This will reflect an assignment of the services in the healthcare delivery network at the specific time with the specific healthcare delivery network configuration. In an embodiment, this operation is implemented using high-productivity high-performance (HP2) computing resources to evaluate a massive number of possible assignment scenarios. This magnitude of mathematical operations has been made practical by the use of high capacity computer power.

Satisfying Constraints

In an embodiment of the process of finding the set, or sets, of optimization variables, αₖₙₘ, for N=100, K=100, and M=24 that has the minimum or near minimum “cost,” it is necessary to ensure that the facilities in the healthcare delivery network have sufficient capacity to satisfy the demand for the healthcare services. In an embodiment, demand can be checked against capacity by:

$${\sum }_{n = 1}^{n <= N} {α}_{knm} * {SA}_{kn} <= {SF}_{km}$$

$$for each facility \text{:}$$

$$m = 1 , … M ( e . g . , M = 24 ) and for each type of service$$

$$k = 1 , … K ( e . g . , K = 100 ) .$$

That is, the expression represents that the ability to provide service Sₖ at facility Fₘ (SFₖₘ) must be greater than or equal to the total amount of services, Sₖ, from demand areas, Aₘ that are assigned to the facility, Fₘ, as indicated by the summation of assignment of services from each area to each facility (αₖₙₘ*SAₖₙ). If SA_{L}, is greater than SFₖₘ for a particular facility Fₘ, the assignment of services is reworked until the constraint is satisfied.

Quality Evaluation Module

Once the services from the demand areas have been assigned to the facilities, it is desirable to evaluate the assignment of services from various aspects that include, for example, operational cost, utilization, and demand satisfaction.

Cost Calculations and Reports

In an embodiment, the output of the quality evaluation module (block 128) includes the operational cost and utilization per facility and service. In an embodiment, the output can also indicate if it is impossible to satisfy the demand with the existing facilities in the healthcare delivery network.

Cost of Network Operation for Given Demand Distribution and Facilities Assignment

In an embodiment, the cost of operation for a given assignment of services (Sₖ) for demand areas (Aₙ) to facilities (Fₘ) (e.g., as indicated by the set of optimization variables, αₖₙₘ, for N=100, K=100, and M=24) is calculated for a specific configuration of the healthcare delivery network. In an embodiment, the cost of operation (OPEX) can be expressed as:

$$OPEX ( Δ T ) = Δ T * {\sum }_{k = 1}^{k <= K} {\sum }_{m = 1}^{m <= M} {CSF}_{km} * {U}_{km}$$

where,
ΔT=T_{end}−Tₛₜₐᵣₜ, which represents the period of time to calculate operational expenses (where Tₛₜₐᵣₜ is the start of the time period and T_{end} is the end of the time period);
CSFₖₘ, which represents the cost of providing a unit of service Sₖ at facility Fₘ during a defined time period (e.g., per month); and

$${U}_{km} = {\sum }_{n = 1}^{n <= N} {α}_{knm} * {SA}_{kn}$$

which represents the “usage,” e.g., the volume of service Sₖ performed at facility Fₘ.

Here, the optimization variables, αₖₙₘ, are taken from the previously described facility assignment module.

Utilization Evaluation

In an embodiment, the utilization rate (e.g., as a percentage of full utilization) is evaluated for each service that is provided at each facility. For example, the utilization rate (as a percentage of full utilization) for each facility and each type of service can be expressed as:

100*Uₖₘ/SFₖₘ

for facilities m=1, . . . M (e.g., M=24) and for the type of service k=1, . . . K (K=100), where Uₖₘ represents the usage of service Sₖ performed at facility Fₘ and SFₖₘ represents the capacity of service Sₖ to be performed at facility Fₘ (e.g., reported on a per-month or per-year basis).

Demand Satisfaction

In an embodiment, the ability of the facilities in the healthcare delivery network to satisfy the demand for services is evaluated. For example, demand satisfaction for the total healthcare delivery network on a per-service type basis can be expressed as:

$${DS}_{k} = {\sum }_{n = 1}^{n <= N} {SA}_{kn} ,$$

where DSₖ represents the total demand for service Sₖ;

$${SS}_{k} = {\sum }_{m = 1}^{m <= M} {SF}_{km} ,$$

where SSₖ represents the total supply of service Sₖ; and

where demand for each type of service k=1, . . . K, is satisfied if DSₖ<=SSₖ.

In an embodiment, results of the above-described operations can be reported for evaluation, including, for example, at the reports and charts module (block 121) as a graphical output on a display device. Table 3 is an example of an assignment of certain services to certain facilities in a healthcare services delivery network, where the information is provided in a graphical output on a display device as a given volume of services performed (e.g., number of visits per month) per facility. Additional information such as capacity to perform the services, utilization of the facilities, and operational cost are also provided in Table 3.

TABLE 3

| | Demand Area | | | | | | | |
|---|---|---|---|---|---|---|---|---|
| | Facility 1 | Facility 1 | Facility 1 | Facility n + 1 | Facility 24 | Facility 24 | Facility 24 | Facility 24 |
| | Type of service | | | | | | | |
| | Internal | Cardio Surgery | Maternity | . . . | Internal | Cardio Surgery | Maternity | . . . |
| | Number of visits per month | | | | | | | |
| | Number | Number | Number | Number | Number | Number | Number | Number |
| | of visits | of visits | of visits | of visits | of visits | of visits | of visits | of visits |
| | per month | per month | per month | per month | per month | per month | per month | per month |
| Area1 | 230 | 38 | 92 | | 30 | 0 | 0 | |
| Area2 | 26 | 35 | 0 | | 120 | 0 | 62 | |
| . . . | | | | | | | | |
| Area50 | 0 | 12 | 0 | | 0 | 0 | 0 | |
| . . . | | | | | | | | |
| Total Visits | 2320 | 470 | 375 | | 5070 | 87 | 463 | |
| Capacity | 2700 | 480 | 500 | | 6000 | 270 | 500 | |
| Utilization | 86% | 98% | 75% | | 84.5% | 32.2% | 92.6% | |
| Operational | $250K | $500K | $250K | | $500K | $300K | $250K | |
| Cost per month | | | | | | | | |

Capital Expense Modeling

Referring back to FIG. 1, at block 112, capital expense (CAPEX) modeling is performed using data from the cost description. In an embodiment, the costs of adding a unit of service to a facility or removing a unit of service from a facility are expressed as:
ASFₖₘ—Cost of adding a unit of service Sₖ at facility Fₘ
RSFₖₘ—Cost of removing a unit of service Sₖ at facility Fₘ.

For example, the cost (in dollars) of adding and removing an emergency room bed at an existing or potential new hospital facility is calculated. In an embodiment in which there are 100 types of service and 24 facilities, there are 2,400 different capital costs for both the cost of adding a unit of service and the cost of removing a unit of service. The CAPEX cost models can be used in the facilities assignment optimization as described below.

Optimization of Service Delivery Network Model

As described above, there are many different parameters that affect the delivery of healthcare services within a geographic region via a healthcare delivery network. For example, the parameters include the demand areas, the types of services provided, the facilities (both existing and planned) that are used to provide the services, the capacity of the facilities to provide the services, the transportation network within the region and associated transportation costs, the capital and operating expenses associated with the services and the facilities, and the relative ranking of services at particular facilities. Additionally, values associated with the parameters tend to change over a desired planning time horizon of, for example, 30 years. Given all of the different dynamic parameters, it is desirable to be able to generate configurations of the healthcare delivery network that are cost-effective over the desired time horizon. In an embodiment, optimization algorithms are implemented in a high-productivity high-performance computing system to generate healthcare delivery network models with the lowest costs (e.g., in terms of CAPEX and OPEX) over the desired time horizon. An embodiment of an implementation of such an optimization algorithm is described below.

An embodiment of a mathematical formulation of the optimization problem that satisfies the specified constraints is presented below. Given a list of existing and potential new facilities, Fₘ, m=1, . . . M, where M is total number of existing and potential new facilities, it is desirable to find SFₖₘ(t)—the capacity to perform medical service of type Sₖ at the facility Fₘ to minimize the sum of the CAPEX and the OPEX. In an embodiment, the optimization problem is expressed as:

min(CAPEX+OPEX)

In an embodiment, the problem is formulated in the time domain, e.g., service demand and facility capacities are functions of time.

Total Cost Modeling (OPEX+CAPEX)

Referring back to FIG. 1, in order to find the minimum of CAPEX+OPEX over a given time horizon for a health delivery network model, the CAPEX and OPEX are calculated for each instance of a health care delivery model at the total cost modeling module (block 116). Since the healthcare delivery network model operates over a give time horizon, the CAPEX and OPEX are calculated in the time domain. An example technique for calculating CAPEX and OPEX over a give time horizon is described below.

Input

TDᵢ—time moments for which demand distribution is specified or projected, i=0, . . . , I. For example:

TD₀=0 current;

TD₁=5 years;

TD₂=10 years;

TD₃=15 years;

TD₄=20 years;

TD₅=25 years; and

TD₆=30 years.

TSⱼ—time moments when facilities network is going to change, j=1, . . . , J. That is, time moments when the ability to supply healthcare services will change. These are essentially changes in CAPEX (e.g., new facility or facilities brought on line, facilities modified, facilities taken offline). For example:
TS₀=0 years—current state;
TS₁=3 years—expected completion of the 1st phase of network reorganization;
TS₂=8 years—expected completion of the 2nd phase of network reorganization; and
TS₃=12 years—expected completion of the 3rd phase of network reorganization;
TS₄=21 years—expected completion of the 4th phase of network reorganization.

CAPEX Calculation

In an embodiment, the CAPEX calculation includes the cost of adding new service capacity and removing old service capacity. In a particular time moment, j, the CAPEX calculation can be expressed as:

$${CAPEX}_{j} = {\sum }_{k = 1}^{k <= K} {\sum }_{m = 1}^{m <= M} {ASF}_{km} ( {TS}_{j} ) * ( {SF}_{km} ( {TS}_{j} ) - {SF}_{km} ( {TS}_{j - 1} ) ) + {RSF}_{km} * ( {SF}_{km} ( {TS}_{j - 1} ) - {SF}_{km} ( {TS}_{j} ) )$$

In an embodiment, the total capital expenditures, CAPEX, over the whole period of time of TS₁ to TS_{J} can be expressed as:

$$CAPEX = {\sum }_{j = 1}^{j <= J} {CAPEX}_{j}$$

OPEX Calculation

For a given network configuration and a given demand distribution, the OPEX calculation is described above. In an embodiment, the OPEX calculation is based on demand that changes as function of time. For example, it is assumed that between TDᵢ and TDᵢ₊₁, demand is constant. This assumption can be relaxed later.

Additionally, J(i) is defined as a time index of facilities network modification TSⱼ for which:

TSⱼ<=TDᵢ and TSⱼ₊₁>TDᵢ

then for the given interval of demand period “I”: TDᵢ<=t<TDᵢ₊₁

$$OPEX = {\sum }_{i = 0}^{I} {OPEX}_{i}$$

$$where$$

$${OPEX}_{i} = {\sum }_{j = J ( i - 1 )}^{j < J ( i )} {OPEX}_{ij}$$

where OPEXᵢⱼ represents the operational expenses during the demand period “i” with network configuration “j”

$${OPEX}_{ij} = ( {T}_{j} - {T}_{j - 1} ) * {\sum }_{k = 1}^{k <= K} {\sum }_{m = 1}^{m <= M} {CSF}_{km} ( j ) * {U}_{km} ( i , j )$$

$$j = J ( i - 1 ) , … , J ( i )$$

where Tⱼ₋₁=TDᵢ if TSⱼ₋₁<=TDᵢ, Tⱼ₋₁=TSⱼ₋ᵢ, otherwise,
Tⱼ=TDᵢ₊₁ if TSⱼ>TDᵢ, Tⱼ=TSⱼ.

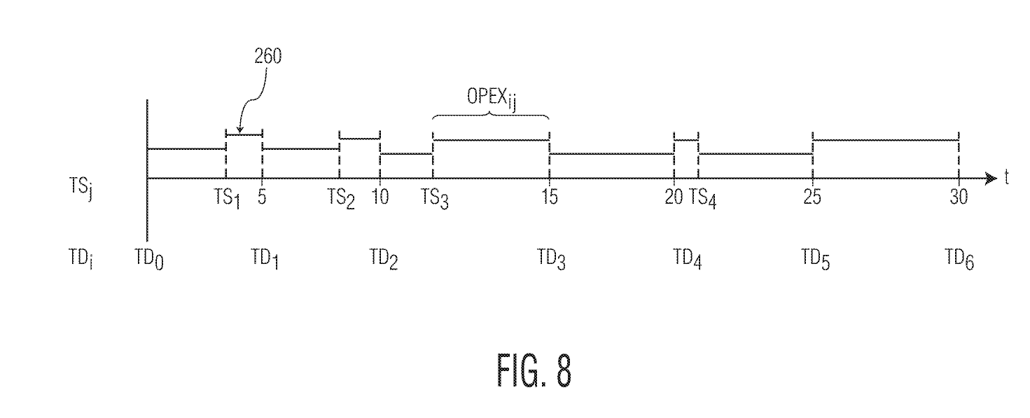

FIG. 8 is a graphical depiction of the time intervals that correspond to each interval of OPEXᵢⱼ in the case where TDᵢ and TSⱼ have the intervals that are described above. In FIG. 8, the time moments at which the demand distribution is specified, TDᵢ, are marked at 0, 5, 10, 15, 20, 25, and 30 years and the time moments at which the facilities network changes, TSⱼ, are indicated at 3, 8, 12, and 21 years. Each unique combination of TDᵢ and TSⱼ is indicated by one of the horizontal bars 260 and represents a time interval at which OPEXᵢⱼ is calculated.

Facilities Network Optimizer

In an embodiment, in order to solve the optimization problem of:

min(CAPEX+OPEX)

it is desirable to modify the configuration of the healthcare delivery network. That is, it is desirable to modify the facilities to change the service capacities of the facilities. Modifications to the facilities may include, for example, adding new facilities (with the ability to perform certain services), to remove facilities (thereby losing the ability to perform certain services), modifying existing facilities (to add or remove services), and making operational changes that change the suite of services that are performed and/or the capacity to perform certain services within a facility. It should be noted that such changes can have associated costs, e.g., capital costs and may result in changes to operation costs. The modifications to the healthcare services delivery network may translate to changes in Fₘ, SFₖₘ, RRSFₖₘ, CSFₖₘ, ASFₖₘ, and RSFₖₘ. In an embodiment, modifications to the healthcare services delivery network are implemented at the service delivery network modification engine (block 120). For example, a user may enter changes to any of the above-described aspects of the healthcare delivery network (e.g., via a user interface) that may translate to changes in, for example, Fₘ, SFₖₘ, RRSFₖₘ, CSFₖₘ, ASFₖₘ, and RSFₖₘ. For example, aspects of the healthcare delivery network that may be changed include the number and location of the facilities, Fₘ, the capacity to perform particular services at facilities, SFₖₘ, the relative ranking, RRSFₖₘ, the cost of providing services at facilities, CSFₖₘ, the cost of adding service, ASFₖₘ, and the cost of removing service, RSFₖₘ.

In an embodiment, space programs for the potential new facilities and/or modifications of existing facilities (e.g., expansion, reduction, reassignment of services) are generated at the service delivery network modification engine (block 120) to try to meet changes in demand as provided by the service demand estimation module (block 108). A space program defines the physical bounds of a facility, including, for example, the total square footage of the facility and the configuration of the square footage. For example, a 100,000 ft² facility could be a single story building with a 100,000 ft² footprint or a ten-story building with 10 floors of 10,000 ft² each and a 10,000 ft² footprint. The space programs possible for a specific facility may also be influenced by the details of the facility location such as, for example, the size of the location and local building restrictions (e.g., building height restrictions). The space programs may subsequently translate to modifications to the facilities and service capacities description (block 104) and to the cost description (block 106).

As stated above, the process of finding min (CAPEX+OPEX) may involve modifying the configuration of the healthcare delivery network, which translates to changes in Fₘ, SFₖₘ, RRSFₖₘ, CSFₖₘ, ASFₖₘ, RSFₖₘ. In an embodiment, changes to Fₘ, SFₖₘ, RRSFₖₘ, CSFₖₘ, ASFₖₘ, RSFₖₘ are made at the service delivery network modification engine (block 120) and repeatedly evaluated by the facilities network optimizer (block 118) to find healthcare services delivery models with the lowest CAPEX+OPEX, e.g., min (CAPEX+OPEX). For example, the changes made at the service delivery network modification engine are considered at the subsequent stages in the process to find new values of CAPEX+OPEX. The processes can be repeated in an iterative process to find desirable values of CAPEX+OPEX, e.g., preferably relatively low values of CAPEX+OPEX and preferably min (CAPEX+OPEX).

As described above, given a list of existing and potential new facilities—Fₘ, m=1, . . . M, where M is total number of existing and potential new facilities, it is desirable to find SFₖₘ(t)—the capacity to perform medical service of type Sₖ at the facility Fₘ to minimize the sum of the CAPEX and the OPEX.

In an embodiment in which K=100, M=24, time period Td=20 years, and the average number of capacity options for each service type for each facility considered during the optimization process is 1000, the total number of variants for this optimization problem is on the order of 100*24*20*1000=4.8*10⁸. Solving a facility assignment problem for each variant may require a number of calculations on the order of 24,000,000=2.4*10⁷. In an embodiment, the total average number of calculations to solve optimization problem is on the order of 4.8*10⁸*2.4*10⁷=1.15*10¹⁶. In an embodiment, this operation is implemented using high-productivity high-performance (HP2) computing resources to evaluate a massive number of possible assignment scenarios. This magnitude of mathematical operations has been made practical by the use of high capacity computer power.

Upon running the optimization algorithm, multiple solutions to the min (CAPEX+OPEX) problem can be evaluated. Each solution represents a healthcare delivery model that defines how services are allocated to the facilities in the network over the desired time horizon, including how to handle changes in the facilities, e.g., when and where to locate new facilities and when and where to modify and/or remove facilities, while also providing the costs associated with each model, e.g., in terms of CAPEX and OPEX. Such information is a powerful tool that can be used by planners in a healthcare organization to make important decisions on how to manage the healthcare delivery network over time. Table 4 represents certain information that can be output (e.g., at the reports and charts module (block 121)) for a particular healthcare delivery model using the above-described techniques. For example, the table identifies the capacity of the healthcare services delivery network to provide the suite of services, Sₖ, on a per-annum basis over the desired time horizon as well as the associated operating expenses (OPEX) and capital expenses (CAPEX) associated with the particular healthcare delivery model.

TABLE 4

| | Internal | Cardio | | | Radiology |
|---|---|---|---|---|---|
| | Capacity | Surgery | Maternity | | Capacity |
| | (Number | Capacity | Capacity | | (Number |
| | of | (Number of | (Number of | | of |
| Type of service | visits per | visits per | visits per | | visits per |
| Year | month) | month) | month) | . . . | month) |
| 2016 | 2700 | 480 | 500 | | 900 |
| 2017 | 2700 | 480 | 500 | | 900 |
| . . . | | | | | |
| 2025 | 1500 | 600 | 500 | | 1200 |
| . . . | | | | | |
| 2035 | 1000 | 700 | 500 | | 1500 |
| Total OPEX | $50M | $150M | $60M | | $180M |
| Total CAPEX | $5M | $30M | $6M | | $50M |

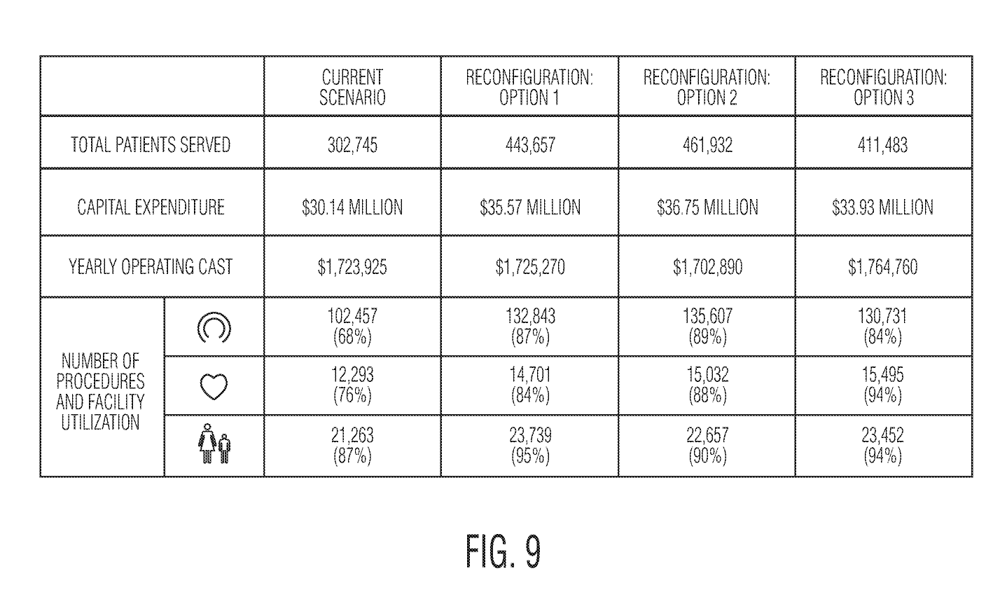

FIG. 9 is another graphical output that can be generated and graphically output using the above-described techniques and that compares various different healthcare delivery network models for the same service region. The graphical output includes a table that compares a “Current Scenario” with “Reconfiguration: Option 1, “Reconfiguration: Option 2,” and “Reconfiguration: Option 3.” The models are compared on the basis of “Total Patients Served,” “Capital Expenditure,” “Yearly Operating Cost,” “Number of Procedures,” and “Facility Utilization,” where the Number of Procedures and Facility Utilization are on a per service type, with the different service types being represented by icons.

Although the techniques have been described above as being applicable to a healthcare delivery network, the techniques are applicable to other service delivery networks. For example, the techniques are applicable to a network of airports used by an airline, a retailer's growth strategy, and sports leagues franchise expansion plans.

In an embodiment, the term “healthcare delivery network configuration” refers to a snapshot of the configuration of the network at a particular time and the term “healthcare delivery network model” refers to a description of healthcare delivery network over time, e.g., multiple time sequenced “configurations” of the network.

In an embodiment, the above described technique can be used to answer: where to locate hospitals and satellite offices of different types and when to increase their numbers and/or capacity to satisfy changing demand and/or to improve market penetration/share (e.g., in markets with multiple competing healthcare organizations).

Computers have been used to mathematically describe, model, simulate, and optimize buildings. However, conventional computer-based techniques utilize PC-based computer platforms with limited computing capacity to perform very specific operations that are focused on a single issue, e.g., structural performance, temperature modeling, or workflow optimization. Because of the inherent limitations of PC-based computing resources, conventional design, modeling, simulation, and optimization operations are forced to rely on relatively crude mathematical models that can only evaluate a few design options in a reasonable amount of time. Because of the complexity of such service delivery networks, it is difficult if not impossible to comprehensively design, model, simulate, or optimize such service delivery networks on a PC computer platform in a manner that will provide significant advances beyond the conventional techniques.

In accordance with an embodiment of the invention, the above described modeling, simulation, and optimization techniques are implemented using high-productivity high-performance (HP2) computing resources. Because HP2 computing resources are used, modeling, simulation, optimization and verification can be performed from a single platform on a scale which heretofore has not been applied to complex service delivery networks. Additionally, the holistic approach to evaluating complex service delivery networks involves using a centralized database to manage all of the information related to the service delivery network.

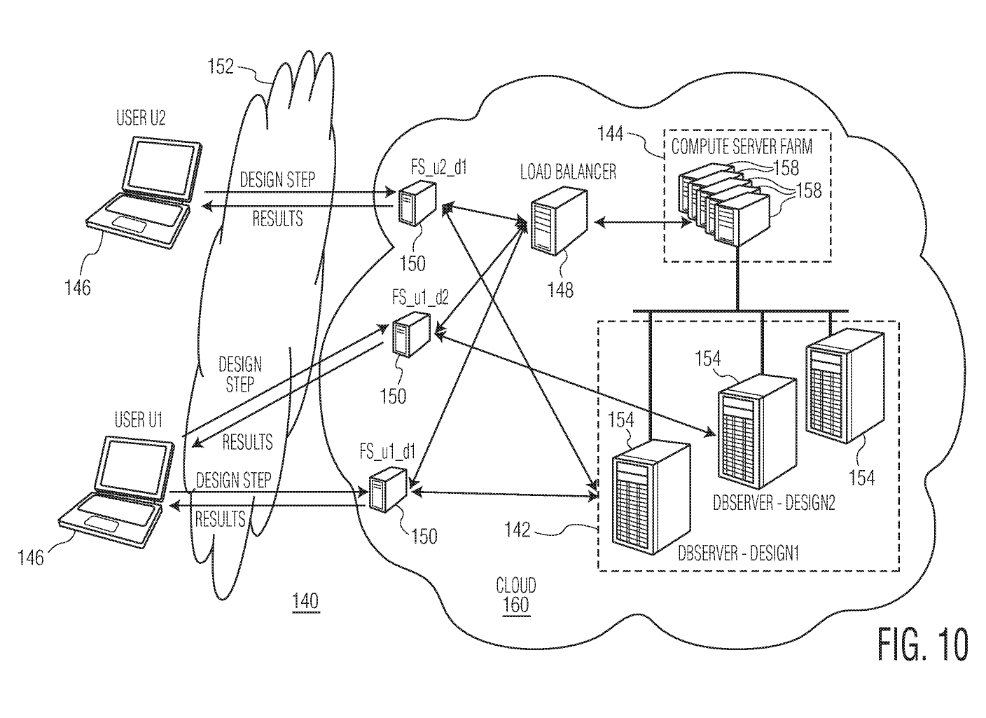

Performing the processes described above typically requires computing resources well beyond what can be provided by typical PC computer systems. FIG. 10 depicts an embodiment of an HP2 computer architecture 140 in which the above-described techniques can be implemented. In particular, the HP2 computer architecture includes a high capacity networked storage system 142, a large scale processing system 144, and user interface devices 146, e.g., client machines. Additionally, load balancers 148 and flow servers 150 may be provisioned from the large-scale processing system.

The user interface devices 146 may be client machines, typically desktop computers, laptop computers, or tablet computers, on which a session can be opened to control the design flow and to view the performance results of a particular service delivery network model. The user interface devices allow a user to provide design intent and invoke design and analysis steps. Results come in to the user interface devices as they become available. In an embodiment, the user interface devices are used to access a browser-based user interface via an access network 152.

The high capacity networked storage system 142 includes memory for storing the software code that is used to implement the above described techniques and for storing data related to multiple different service delivery network configurations and models that are generated. In the embodiment of FIG. 10, the high-capacity network storage system includes a networked combination of storage servers 154 that provide storage capacity on the order of Terabits of data.

In an embodiment, the large-scale processing system 144 performs the computer processing that is necessary to implement the above-described techniques. For example, the large-scale processing system performs high-volume mathematical computations to implement the modeling, simulations, and optimizations. In an embodiment, the large scale processing system includes multiple servers 158 (i.e., a server farm or compute farm) that each have many high-speed processors (e.g., on the order of thousands and up), where the individual servers are connected to each other by high-speed network links such as Gigabit Ethernet. Such large scale processing systems can perform on the order of Tera-(10¹²) to Peta-(10¹⁵) floating point operations per second (Flops), referred to as TFlops and PFlops, respectively. Examples of large scale processing systems include the CRAY XT3, having 3,328 processing cores and the CRAY XT5, having 14,752 processing cores. In an embodiment, the large scale processing system utilizes a grid computing architecture and/or multi-core processors to implement distributed computing according to a “MapReduce” framework. Although examples of the large-scale processing system are described, other large-scale processing systems are possible.

The flow servers 150, which can be virtual, one per user interface device 146 and design step, may be compute engines borrowed from the large scale processing system 144 (e.g., server farm), which execute the instructions that implement the process flow. For computationally intensive tasks, the flow servers submit processing jobs (i.e., computational tasks) to the load balancer 148 and the load balancer distributes the computational tasks based on project, user, and task priorities.

Compute servers 158 of the large-scale processing system 144 are used by the flow servers 150 to perform computational intensive tasks using, for example, map reduced or “MapReduce” techniques for parallel processing. In an embodiment, the compute servers are pooled among flow servers by the load balancer 148. The compute servers can pull large amounts of design information directly from the database servers 154 of the high capacity network storage system 142 and save raw results back to the storage system.

In an embodiment, some or all of the computing resources (excluding the user interface devices) are provided as a “cloud service.” For example, the HP2 computing resources of FIG. 10 are provided as a cloud service within a network cloud 160. That is, the computing resources are not owned by the owner or user of the service delivery network, but are instead utilized and paid for on an as needed basis. For example, cloud services such as those provided by Amazon Web Services (AWS) may be utilized to implement the above-described techniques.

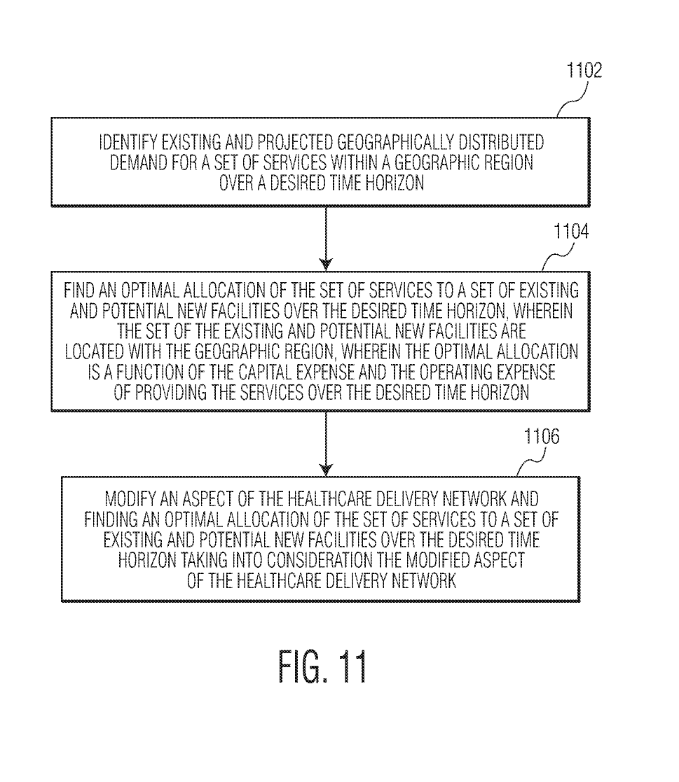

FIG. 11 is a process flow diagram of a method for evaluating a service delivery network for a geographic region that provides a set of services via a set of facilities within the geographic region. At block 1102, existing and projected geographically distributed demand for a set of services within the geographic region is identified over a desired time horizon. At block 1104, an optimal allocation of the set of services to a set of existing and potential new facilities is found over the desired time horizon, wherein the set of existing and potential new facilities are located within the geographic region and wherein the optimal allocation is a function of the capital expense and the operating expense of providing the services over the desired time horizon. At block 1106, an aspect of the healthcare delivery network is modified and an optimal allocation of the set of services to a set of existing and potential new facilities is found over the desired time horizon taking into consideration the modified aspect of the healthcare delivery network.

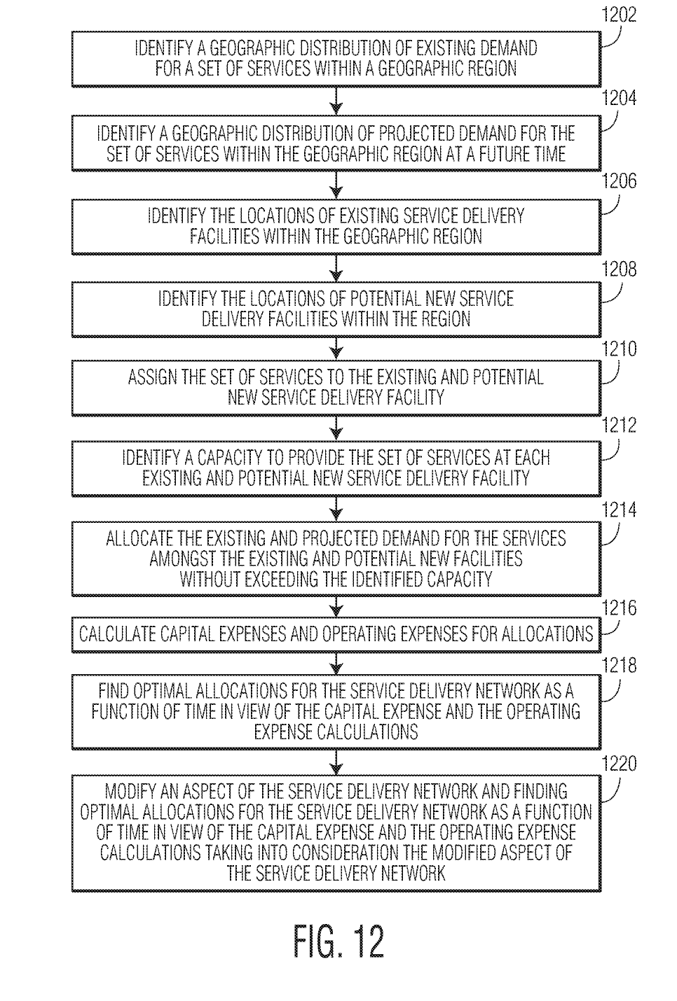

FIG. 12 is a process flow diagram of a method for evaluating a service delivery network for a geographic region. At block 1202, a geographic distribution of existing demand for a set of services within a geographic region is identified. At block 1204, a geographic distribution of projected demand for the set of services within the geographic region at a future time is identified. At block 1206, the locations of existing service delivery facilities within the geographic region are identified. At block 1208, the locations of potential new service delivery facilities within the region are identified. At block 1210, the set of services are assigned to the existing and potential new service delivery facilities. At block 1212, a capacity to provide the set of services at each existing and potential new service delivery facility is identified. At block 1214, the existing and projected demand for the services is allocated amongst the existing and potential new facilities without exceeding the identified capacity. At block 1216, capital expenses and operating expenses for the allocations are calculated. At block 1218, optimal allocations for the service delivery network are found as a function of time in view of the capital expense and the operating expense calculations. At block 1220, an aspect of the service delivery network is modified and optimal allocations for the service delivery network as a function of time are found in view of the capital expense and the operating expense calculations taking into consideration the modified aspect of the service delivery network.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods and/or the blocks described herein may be implemented using software instructions stored on a non-transitory computer useable storage medium for execution by a computer. As an example, an embodiment of a computer program product includes a computer useable non-transitory storage medium to store a computer readable program that, when executed on a computer, causes the computer to perform operations, as described herein.

Furthermore, embodiments of at least portions of the invention can take the form of a computer program product accessible from a computer-usable or non-transitory computer-readable storage medium providing computer executable instructions, or program code, for use by or in connection with a computer or any instruction execution system. For the purposes of this description, a non-transitory computer-usable or computer readable medium can be any apparatus that can contain or store the program for use by or in connection with the instruction execution system, apparatus, or device.

The computer-useable or computer-readable storage medium can be an electronic, magnetic, optical, electromagnetic, infrared, or semiconductor system (or apparatus or device). Examples of a non-transitory computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In an embodiment, the above-described functionality is performed by a computer or computers, which executes computer readable instructions. For example, a computer that includes a processor, memory, and a communications interface. The processor may include a multifunction processor and/or an application-specific processor. Examples of processors include the PowerPC™ family of processors by IBM and the x86 family of processors by Intel such as the Xeon™ family of processors and the Intel X5650 processor. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer based method for evaluating a service delivery network for a geographic region that provides a set of services via a set of facilities within the geographic region, the method comprising:
identifying existing and projected geographically distributed demand for a set of services within the geographic region over a desired time horizon; and
finding an optimal allocation of the set of services to a set of existing and potential new facilities over the desired time horizon, wherein the set of existing and potential new facilities are located within the geographic region;
wherein the optimal allocation is a function of the capital expense and the operating expense of providing the services over the desired time horizon.

2. The computer based method of claim 1, wherein the method further comprises modifying an aspect of the healthcare delivery network and finding an optimal allocation of the set of services to a set of existing and potential new facilities over the desired time horizon taking into consideration the modified aspect of the healthcare delivery network.

3. The computer based method of claim 2, wherein identifying existing and projected geographically distributed demand for a set of services within the geographic region over a desired time horizon comprises defining demand as follows:
Aₙ—demand area, n=1, . . . N, where N is the total number of areas served by the healthcare delivery network;
Sₖ—Type of medical service, k=1, . . . K, where K is the total number of services considered;
Fₘ—Facility at given location (Xₘ, Yₘ), m=1, . . . M, where M is total number of existing and potential new facilities;
SFₖₘ—capacity to perform medical service of type Sₖ at the facility Fₘ;
SAₖₙ(t)—estimated demand for service Sₖ from the demand area Aₙ at time, t; and
RRSFₖₘ—relative ranking of medical service of type Sₖ at the facility Fₘ.

4. The computer based method of claim 3, wherein finding an optimal allocation of the set of services to a set of existing and potential new facilities over the desired time horizon, wherein the set of existing and potential new facilities are located within the geographic region, comprises solving for:
$$min {\sum }_{k = 1}^{k <= K} {\sum }_{m = 1}^{m <= M} {\sum }_{n = 1}^{n <= N} {α}_{knm} * {TAF}_{nm} * {RRSF}_{km} * {SA}_{kn}$$
where,
TAFₙₘ—unit cost of transportation between area Aₙ and facility Fₘ;
RRSFₖₘ—relative ranking of providing service Sₖ at facility Fₘ; and
SAₖₙ—demand for service Sₖ from the area Aₙ;
where,
0<=αₖₙₘ<=1, where, αₖₙₘ, represents the portion of service Sₖ for demand area Aₙ that is assigned to facility Fₘ;
and;
$${\sum }_{k = 1}^{k <= K} {α}_{knm} = 1.$$

5. The computer based method of claim 4, further comprising ensuring that the following constraint is satisfied:
$${\sum }_{n = 1}^{n <= N} {α}_{knm} * {SA}_{kn} <= {SF}_{km}$$
for each facility: m=1, . . . M and for each type of service k=1, . . . K.

6. The computer based method of claim 5, further comprising calculating the operating expense as:
$$OPEX = {\sum }_{i = 0} {OPEX}_{i}$$
$$where , \\ {OPEX}_{i} = {\sum }_{j = J ( i - 1 )}^{j < J ( i )} {OPEX}_{ij}$$
where OPEXᵢⱼ represents the operational expenses during the demand period “i” with network configuration “j”;
$${OPEX}_{ij} = ( {T}_{j} - {T}_{j - 1} ) * {\sum }_{k = 1}^{k <= K} {\sum }_{m = 1}^{m <= M} {CSF}_{km} ( j ) * {U}_{km} ( i , j )$$
$$j = J ( i - 1 ) , … , J ( i )$$
where Tⱼ₋₁=TDᵢ if TSⱼ₋₁<=TDᵢ, Tⱼ₋₁=TSⱼ₋₁, otherwise,
Tⱼ=TDᵢ₊₁ if TSⱼ>TDᵢ, Tⱼ=TSⱼ;
where,
TDᵢ—time moments for which demand distribution is specified or projected, i=0, . . . , I; and
TSⱼ—time moments when facilities network is going to change, j=1, . . . , J.

7. The computer based method of claim 6, further comprising calculating the capital expense as:
$$CAPEX = {\sum }_{j = 1}^{j <= J} {CAPEX}_{j}$$
$$where , \\ {CAPEX}_{j} = {\sum }_{k = 1}^{k <= K} {\sum }_{m = 1}^{m <= M} {ASF}_{km} ( {TS}_{j} ) * ( {SF}_{km} ( {TS}_{j} ) - {SF}_{km} ( {TS}_{j - 1} ) ) + {RSF}_{km} * ( {SF}_{km} ( {TS}_{j - 1} ) - {SF}_{km} ( {TS}_{j} ) )$$
ASFₖₘ—cost of adding a unit of service Sₖ at facility Fₘ; and
RSFₖₘ—cost of removing a unit of service Sₖ at facility Fₘ.

8. The computer based method of claim 7, wherein the optimal allocation is expressed as: min (CAPEX+OPEX).

9. A computer based method for evaluating a service delivery network for a geographic region, the method comprising:
identifying a geographic distribution of existing demand for a set of services within a geographic region;
identifying a geographic distribution of projected demand for the set of services within the geographic region at a future time;
identifying the locations of existing service delivery facilities within the geographic region;
identifying the locations of potential new service delivery facilities within the region;
assigning the set of services to the existing and potential new service delivery facilities;
identifying a capacity to provide the set of services at each existing and potential new service delivery facility;
allocating the existing and projected demand for the services amongst the existing and potential new facilities without exceeding the identified capacity;
calculating capital expenses and operating expenses for the allocations;
finding optimal allocations for the service delivery network as a function of time in view of the capital expense and the operating expense calculations.

10. The computer based method of claim 9, wherein the method further comprises modifying an aspect of the service delivery network and finding optimal allocations for the service delivery network as a function of time in view of the capital expense and the operating expense calculations taking into consideration the modified aspect of the service delivery network.
